(19) United States
(12) Patent Application Publication
(10) Pub. No.: US 2012/0008197 A1
(43) Pub. Date: Jan. 12, 2012

(54) MICROSCOPE, MORE PARTICULARLY FLUORESCENCE MICROSCOPE, DICHROIC BEAM SPLITTER AND USE THEREOF

(76) Inventors: Sebastian Borck, Jena (DE); Wolfgang Bathe, Jena (DE)

(21) Appl. No.: 13/176,032

(22) Filed: Jul. 5, 2011

(30) Foreign Application Priority Data
Jul. 6, 2010 (DE) 102010026205.6

(51) Int. Cl. G02B 21/06; G02B 27/28

(52) U.S. Cl. 359/386; 359/487.04

(57) ABSTRACT

The invention relates to a microscope, more particularly to a fluorescence microscope, for the structured illumination microscopy, comprising a microscope light path having an optical axis, including a beam splitter for coupling illumination light into the microscope light path, including an illumination pattern unit disposed, in particular, in the microscope light path for the purpose of generating an illuminated pattern on, or in, a sample to be examined, comprising a rotary device for the purpose of effecting relative rotation about the optical axis between the illumination pattern and the sample to be examined. The microscope is characterized in that a rotary polarizing device is provided for the purpose of rotating a polarization of the illumination light, that the angular positions of the rotary device and of the rotary polarizing device are inflexibly coupled to each other, that in order to reduce polarization effects during relative rotation between the illumination pattern and the beam splitter, a beam splitter is used which reflects and/or transmits the incident illumination light while substantially maintaining the polarization state, and/or that in order to reduce polarization effects while effecting relative rotation between the illumination pattern and the beam splitter, a beam splitter is positioned in the optical path such that the angle of incidence of the illumination light relative to a surface normal vector of the beam splitter is less than 45 degrees. The invention also relates to a dichroic beam splitter and to the use thereof in a fluorescence microscope.

The present invention relates, in a first aspect, to a microscope, more particularly to a fluorescence microscope, for structured illumination microscopy as defined in the generic clause of claim 1.

In further aspects, the invention relates to a dichroic beam splitter and the use thereof.

A generic microscope, more particularly a fluorescence microscope, for structured illumination microscopy comprises the following components: a microscope light path having an optical axis, a beam splitter for coupling illumination light into the microscope light path, an illumination pattern unit disposed, in particular, in the microscope light path for forming an illumination pattern on, or in, a sample to be examined, and a rotary mechanism for effecting a relative rotation about the optical axis between the illumination pattern and the sample to be examined.

In high-resolution Structured Illumination Microscopy (SIM), fluorescence excitation light is projected onto, or into, a sample, for example in the form of a striped pattern that can be displaced orthogonally to the direction of the lines by appropriate technological methods.

From a number of images comprising striped patterns that are displaced relatively to each other it is possible to compute an image by means of suitable algorithms, which image has higher resolution in a direction extending at right angles to the line structure, that is, along the direction of displacement, as opposed to the method involving limited diffraction.

The method generally accepted as being advantageous for this purpose is one involving multiple-beam interference of the excitation light.

For this purpose, collimated excitation light is first split by means of an optical grating into light of different orders of diffraction that are focused into the pupil of a microscope objective lens by means of a tube lens. The objective then forms images of the individual orders of diffraction in the form of plane waves in the object plane, and the beams display interference at a given coherence across the illumination field. The enhancement of resolution that can be achieved depends primarily on factors such as modulation frequency and modulation depth, the magnitude of which must in both cases be as great as possible. The modulation frequency of the interference pattern can be maximized by positioning the focal points of the excitation light as far away as possible at the edge of the pupil.

There, two beams that are focused into the mutually opposing edge regions of the pupil form two plane waves that travel toward each other at an obtuse angle in the case of an objective of high numerical aperture and have an interference frequency that is close to half the wavelength. Additional interferences can occur when additional sub beams are used for multiple-beam interference. Typically, light of two orders of diffraction, for example, light of the first and “minus-first” orders of diffraction of the grating is used at the edges of the pupil. Optionally, a beam of the zero order of diffraction that is focused into the center of the pupil can be additionally used. The latter is used particularly for enhancing the z-resolution, while the two outer beams of different orders of diffraction contribute to enhancement of the lateral resolution.

The degree of modulation contrast achievable depends on the polarization of the light used for structured illumination relative to the plane spanned by the beams of different orders of diffraction. If the plane of polarization is located in the diffraction plane, the directions of oscillation of the electric field of the different sub beams are not exactly collinear to each other and the modulation contrast is reduced, since no interference takes place for non-collinear field components. These non-interfering components are thus superposed on the interference pattern in the form of a constant background.

This problem does not occur when the polarization of the sub beams is perpendicular to the diffraction plane, that is, the plane spanned by the beams of different orders of diffraction. In this case, the electric field vectors are always collinear and a modulation contrast of almost 100% is possible.

In structured illumination microscopy, an enhancement of resolution is achieved only in the modulation direction of the illumination field. Consequently, to achieve an isotropic enhancement of resolution, it is necessary to rotate the direction of structuring and thus the orientation of the three orders of diffraction. Usually, three or five directions are used for this purpose.

In an incident light fluoresence setup as commonly used nowadays in microscopes, the source of excitation is attached to the rear port of the microscope and the excitation light is reflected into the microscopical light path by means of a 45° colour splitter. The fluorescence emitted by the object is imaged by the objective lens in an image plane. The path of the light to be detected extends back, in a basically known manner, up to the beam splitter collinearly in the direction opposing that of the excitation light path, where it is separated from the latter due to the different spectral properties of the beam splitter. Collection of the emitted fluorescence is then carried out by means of, say, a camera.

An essential aspect is that, in known dichroic beam splitters such as those commonly used at an incident angle of 45°, the reflection for s-polarization and p-polarization is not the same with respect to the plane of reflection. Apart from amplitude effects, the layer architecture of the beam splitter can result in different phase terms for the two directions of polarization in reflection. Therefore, if the polarization is not exactly s-oriented or p-oriented, this results in an alteration of the overall polarization state, since the beam splitter acts similarly to a λ/2 or λ/4 plate. Accordingly, in the extreme case, the polarization can be rotated through 90°or, alternatively, a linear polarization can be elliptical or even circular. When such a setup is used for SIM, there are different modulation contrasts in different directions.

This problem is further intensified by the fact that it is preferable to have an odd number of structuring orientations so that it is generally not possible for the orientation of the orders of diffraction or polarization to be restricted along the p-plane or s-plane.

The images resulting in SIM accordingly contain resolution anisotropies and undesirable image artifacts unless corrective measures are taken for counteracting the disruptive influence of the beam splitter on polarization.

By contrast, when the incident angle of the excitation light is 0°, the properties of interference filters with respect to polarization are degraded, that is, the reflective properties are not dependent on the direction of polarization. However, it is not possible under these conditions to use an incident light setup, since geometric splitting of the excitation light path from the detection light path cannot take place. In this case, only transmitted light illumination can be used, which is not suitable for fluorescence microscopy applications in general, and for SIM in particular, due to various practical disadvantages.

It may be regarded as being an object of the invention to provide a microscope by means of which resolution anisotropies can be significantly reduced. This object is achieved by means of a microscope having the features defined in Claim 1.

A further object of the invention is a dichroic beam splitter, the features of which are de-fined in Claim 13 and the use of which is defined in Claim 14.

The microscope of the aforementioned type is improved on by the present invention in that a rotary polarizing device is provided for rotating a polarization of the illumination light, that the angular positions of the rotary mechanism and of the rotary polarizing device are inflexibly coupled to each other, that a beam splitter is used for reducing polarization effects when the illumination pattern is rotated relatively to the beam splitter, which beam splitter reflects and/or transmits incident illumination light while retaining the polarization state as far as possible and/or, that for the purpose of reducing polarization effects when the illumination pattern is rotated relatively to the beam splitter, the beam splitter is positioned in the light path in such a way that the incident angle of the illumination light relative to a surface normal vector of the beam splitter is less than 45°.

In the preliminary stages leading to the invention, the inventors initially found that the use of conventional dichroic beam splitters for the structured illumination microscopy can result in different modulation contrasts in different directions.

The inventors then found that the images resulting in SIM accordingly contain resolution anisotropies and unwanted image artifacts unless corrective measures be taken to dispel the disruptive influences of the beam splitter on polarization.

Finally, the inventors found that the modulation contrast and thus the polarization relative to the array of orders of diffraction must remain unaltered in order to achieve constant enhancement of resolution in all directions in space. This finding, according to which the polarization must be rotated together with the array of orders of diffraction in order to achieve an isotropic resolution enhancement in SIM, forms the basis of a first central concept of the invention, namely, the provision of a rotary polarizing device for rotating a polarization of the illumination light, by means of which the angular positions of the rotary mechanism and of the rotary polarizing device are inflexibly coupled to each other.

It may be regarded as being a second central concept of the invention to use a beam splitter that reflects and/or transmits incident illumination light while retaining the polarization state as far as possible. By this means it is not possible for the aforementioned problems to occur at all, since a rotation of the direction of illumination or a rotation of polarization through any desired angle relative to the beam splitter does not result in an alteration of the polarization state. Thus, in the case of SIM, a maximum modulation depth of the interference contrast can be achieved irrespective of the orientation of the illumination pattern, that is, the orientation of the structuring direction.

According to a further fundamental concept of the invention, the beam splitter can additionally or alternatively be positioned in the light path such that the incident angle of the illumination light relative to a surface normal vector of the beam splitter is less than 45°. This solution is based on the finding that the differences between the individual polarizations diminish as the incident angle of the illumination light measured relative to the surface normal vector of the beam splitter decreases. In the extreme case of a normal, that is, perpendicular incidence, there is no difference between p-polarization and s-polarization.

Preferably, the illumination pattern unit can be disposed in the microscope light path or at all events in the illumination light path.

Very preferably, a beam splitter is used at an incident angle of less than 45°, at which the differences in reflective properties for the different directions of polarization with regard to amplitude and phase offset or phase retardation are negligible for the relevant application of the structured illumination microscopy.

In very advantageous embodiments of the microscope of the invention, the beam splitter is installed at an angle relative to the optical axis such that the incident angle of the illumination light relative to the optical axis is less than 25°, preferably less than 20°, more preferably less than 15° and most preferably less than 10°. In the aforementioned angular ranges, the differences in reflective properties for the different directions of polarization with regard to amplitude and phase retardation are largely insignificant in the use of the structured illumination microscopy and they become increasingly negligible as the angle decreases.

Usually, the beam splitter used is a dichroic beam splitter. With respect to the first central concept of the invention explained above, the layer architecture of the beam splitter can be such that, for discrete wavelengths to be reflected, phase retardations for s-polarization or p-polarization in reflection are equal to each other or differ from each other only by an integral multiple of 180°. It is thus possible to satisfy the requirement that incident illumination light should be reflected while largely retaining the polarization state. For retention of the direction of polarization following reflection by the beam splitter, the s-polarized and p-polarized components of the illumination light must additionally be reflected identically as far as possible with regard to their amplitudes.

In principle, the microscope of the invention is not restricted to any given contrasting principle, such as fluorescence microscopy, or a given type of illumination such as incident illumination or transmitted illumination. However, the advantages of the invention are most obvious when the microscope is a fluorescence microscope, in which measurements are carried out in incident-light geometry.

The essential factor concerning the illumination pattern unit is that the desired enhancement of resolution is achieved by means of the generated illumination pattern and the corresponding evaluation algorithm.

In very preferred variants of the microscope of the invention, the illumination pattern unit comprises at least one diffraction device for splitting the illumination light into light of different orders of diffraction, and optical means for combining the light of different orders of diffraction on, or in, the sample. The desired light patterns can be readily produced by means of diffraction and subsequent multiple-beam interference. Very preferably, diffraction gratings are used for this purpose.

Advantageously, at least one objective is provided as optional means for transmitting the illumination light onto, or into, a sample.

Advantageously, the rotary mechanism and the rotary polarizing device are configured so as to be capable of rotating continuously within at least one angular range. Within this angular range, the enhancement of resolution can be utilized in all directions.

Very preferably, the angular range within which the rotary mechanism and the rotary polarizing device are configured to rotate continuously is at least 180°. The enhancement of the resolution is then possible in all directions normal to the optical axis of the system.

A reflector turret can be provided for the accommodation of a plurality of beam splitters. In principle, the beam splitters can be installed therein at different angles relative to the optical axis.

As explained above, the illumination pattern can be generated by means of diffraction, that is to say, by interference. In very preferred variants of the microscope of the invention, light of the first order of diffraction is used for multiple-beam interference.

Preferably, light of the zero order of diffraction can additionally be used for multiple-beam interference in order to enhance the resolution in the direction of the optical axis, that is, in the z direction.

In principle, the case of said rotary mechanism, it is only important that the illumination pattern be rotated relatively to the sample. This could basically also be achieved by positioning the sample itself on a rotary table such that it can be rotated relatively to an illumination pattern, which is then stationary. The aforementioned resolution anisotropies would then not occur, since all optical components of the illumination pattern unit could be positioned so as to be immovable with respect to each other. However, this is not carried out in practice due, inter alia, to the associated high demands on the mechanical precision of the rotary table.

In principle, the rotary mechanism can be a mechanical rotary mechanism. For example, at least the diffraction grating can be rotated for the purpose of rotating the illumination pattern. In particularly preferred embodiments of the microscope of the invention, the rotary mechanism is an optical rotary mechanism that can comprise particularly one or more Abbe-Koenig prisms.

A further object of the invention is a dichroic beam splitter, the layer architecture of which is such that, for discrete wavelengths to be reflected, phase retardations for s-polarization and p-polarization in reflection are equal to each other or differ from each other only by an integral multiple of 180°, particularly when the incident angle is 45° relative to a surface normal vector of the beam splitter.

Finally, the use of such a beam splitter in a microscope, in particular in a fluorescence microscope, and more particularly in a microscope according to the invention is claimed.

Additional advantages and characteristics of the invention are described below with reference to the attached diagrammatic figures, in which:

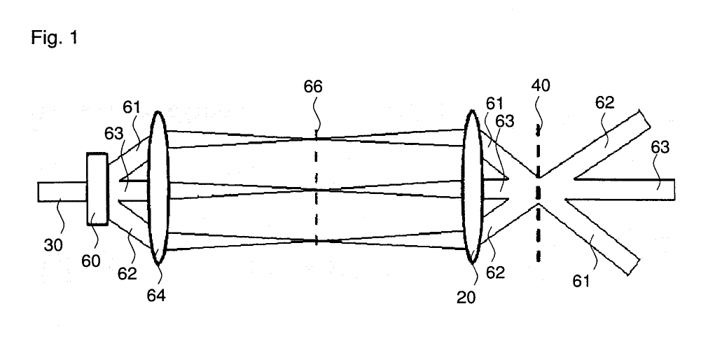

FIG. 1 is a diagrammatic representation of the generation of an illumination pattern by means of multiple-beam interference;

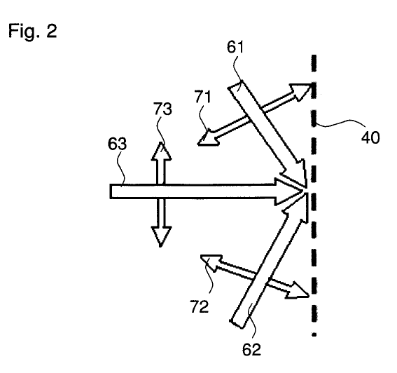

FIG. 2 is a diagrammatic representation of the situation when p-polarized light is used;

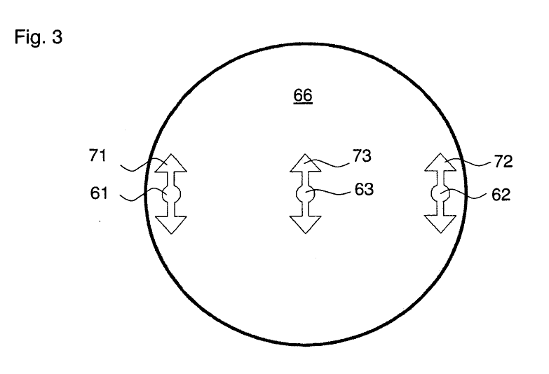

FIG. 3 is a diagrammatic representation of the situation when s-polarized light is used;

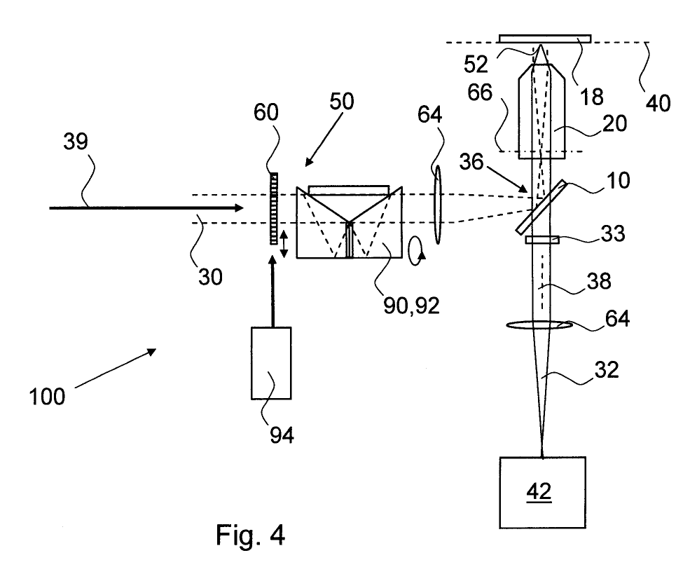

FIG. 4 is a diagrammatic view of a first exemplary embodiment of a fluorescence microscope of the invention;

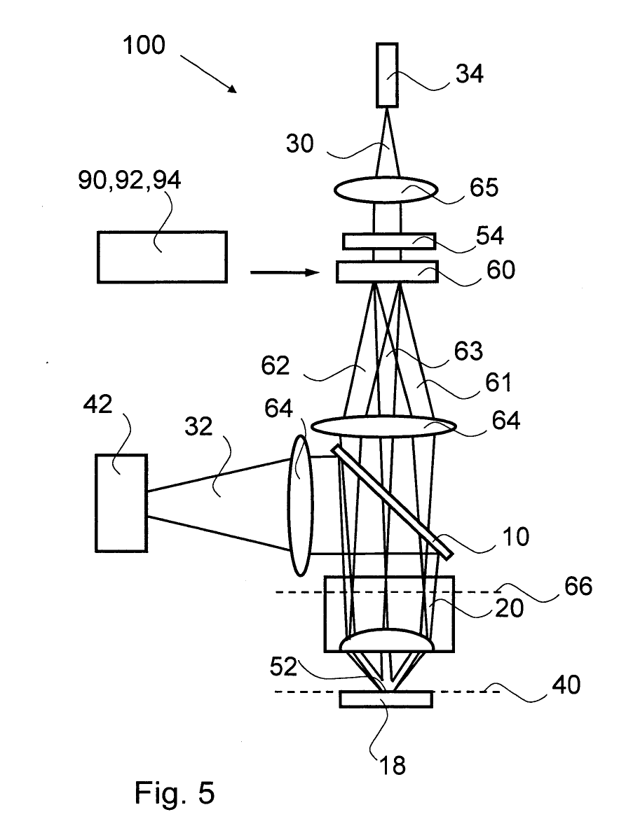

FIG. 5 is a diagrammatic representation of a second exemplary embodiment of a fluorescence microscope of the invention; and

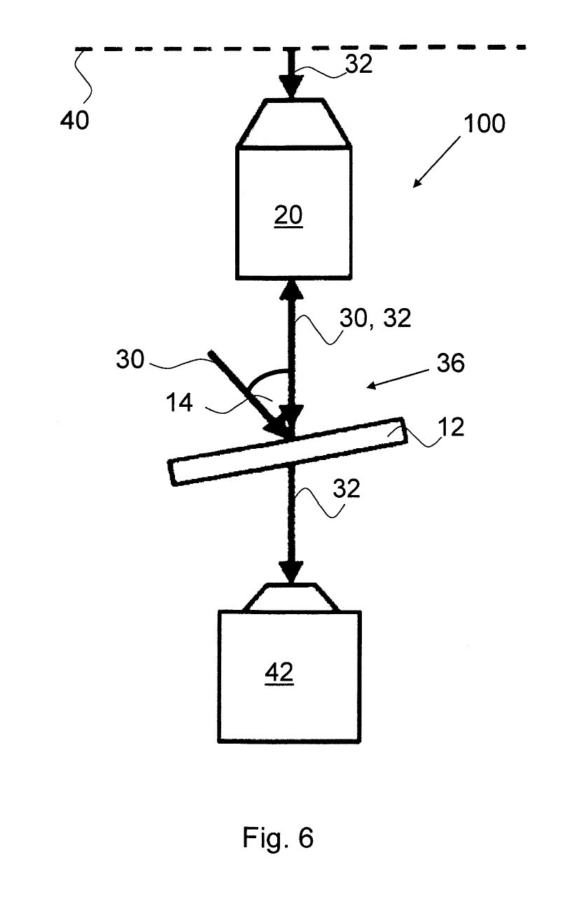

FIG. 6 is a diagrammatic representation of a third exemplary embodiment of a fluorescence microscope of the invention.

The basic physical situation will first be explained with reference to FIGS. 1 to 3. Equivalent components and elements are denoted by the same reference numerals in all figures.

A method generally accepted as being advantageous for producing an illumination pattern that is suitable for structured illumination microscopy with the aid of multiple-beam interference of the excitation light will now be explained with reference to FIG. 1. This figure shows the situation involving triple beam interference. For this purpose, collimated excitation light or illumination light 30 is first split by means of an optical grating 60 into light 61, 62, 63 of different orders of diffraction that is focused into the pupil 66 of a microscope objective 20 by means of a tube lens 64. Light of the first and “minus-first” orders of diffraction is denoted by reference numerals 61 and 62 respectively. Light of the zero order of diffraction is denoted by the reference numeral 63. The objective 20 than images the individual orders of diffraction 61, 62, 63 in the form of plane waves in the object plane 40, and the beams show interference at a given coherence across the illumination field.

As explained with reference to FIGS. 2 and 3, the modulation contrast achievable depends on the polarization of the light used for the structured illumination relative to the plane spanned by the beams of different orders of diffraction. FIG. 2 shows a situation in which the directions of oscillation of the electric field of the individual sub beams 61, 62, 63 are located in the plane of incidence, that is, the plane spanned by the direction of incidence and the surface normal vector of the object plane 40. The plane of incidence in FIG. 2 is coincident with the plane of the drawing. The directions of oscillation of the electric field, that is, the directions of polarization, are denoted by the reference numerals 71, 72, 73 in FIG. 2. Thus there is p-polarization in the situation shown in FIG. 2. If the plane of polarization, as shown in FIG. 2, is located in the diffraction plane, that is, the plane spanned by the beams of different orders of diffraction 61, 62, 63, the directions of oscillation of the electric field 71, 72, 73 of the individual sub beams 61, 62, 63 are not collinear to each other, as shown clearly in FIG. 2. The modulation contrast is thus reduced, since no interference takes place for non-collinear field components. Such a problem is particularly pronounced when light 63 of the zero order is used in the marginal region of the pupil 66 in addition to the two orders of diffraction 61, 62.

This problem does not occur when the directions of oscillation of the electric field 71, 72, 73 of the individual sub beams 61, 62, 63 are located perpendicularly to the plane spanned by the sub beams of the orders of diffraction 61, 62, 63. In this case, the polarization, that is, the directions of oscillation of the electric field, is always collinear, and a modulation contrast of almost 100% is possible. This situation is represented diagrammatically in FIG. 3, where the directions of oscillation 71, 72, 73 of the individual sub beams 61, 62, 63 are shown in the plane of the pupil 66.

In order to achieve a modulation contrast of almost 100%, the array of the sub beams of different orders of diffraction 61, 62, 63 and the directions of oscillation of the electric field 71, 72, 73, that is, the polarization in the pupil 66 should, for structured illumination microscopy, correspond to the situation shown in FIG. 3.

A first exemplary embodiment of a microscope 100 of the invention will now be explained with reference to FIG. 4. The essential components of this microscope 100 include a beam splitter 10 for coupling excitation light 30 into the microscope light path 36, an illumination pattern unit 50 disposed in the illumination light path 39 for the purpose of generating an illumination pattern 52 on, or in, a sample 18 to be examined, a rotary mechanism 90 for causing rotation of the illumination pattern 52 relatively to the sample 18 to be examined about an optical axis 38 of the microscope light path 36, and a rotary polarizing device 92. The essential component of the illumination pattern unit 50 is a diffraction grating 60.

In the setup represented diagrammatically in FIG. 4, illumination light 30 impinges on the diffraction grating 60, which splits the illumination microscopical light 30, as explained above with reference to FIG. 1, into light of different orders of diffraction. The illumination light 30 split into three sub beams is then reflected into the microscopical light path 36 of the microscope 100 of the invention with the aid of a beam splitter 10 of the invention. As shown in FIG. 1, the light of different orders of diffraction is focused into the pupil 66 of an objective 20 by means of a tube lens 64. The objective lens 20 transmits the light of different orders of diffraction focused into the pupil 66, in the form of plane waves, to the sample 18 disposed in the object plane 40. There, the desired illumination pattern 52 is formed by multiple-beam interference of the light of different orders of diffraction, as described above. Light 32, more particularly fluorescent light reflected by the sample 18, travels along the same optical path back up to the beam splitter 10, but partly passes through the same due to its different wavelength and can be subsequently detected with the aid of a suitable detecting device, such as a camera 42.

An emission filter 33 is provided between the beam splitter 10 and an additional tube lens 64 for the selective detection of fluorescent dyes.

A mechanical displacement device 94 is provided for displacing the diffraction grating 60 in a direction orthagonal to the optical axis of the illumination beam path 39.

FIG. 4 shows a 45° geometry, that is, the excitation light 30 impinges on the beam splitter 10 at an angle of 45° relatively to a surface normal vector of the beam splitter. In order to prevent the detrimental effect described above in detail, more particularly the reduced modulation contrast in certain angular positions of the rotary mechanism and of the rotary polarizing device, the beam splitter 10 is, according to the invention, a dichroic beam splitter, the layer architecture of which is such that, for discrete wavelengths to be reflected into the system, phase retardations for s-polarization or p-polarization in reflection are equal to each other or differ from each other only by an integral multiple of 180°.

With this microscope technology, an illumination pattern of the type described above makes it possible to enhance the resolution in the structuring direction, that is, in the direction of emanation of the light of different orders of diffraction. In order to utilize this resolution enhancement in all directions normal to the optical axis 38 of the microscope 100, a rotary mechanism 90 is provided, by means of which at least components of the illumination pattern unit 50 are rotated about an optical axis of the illumination beam path and thus relatively to the sample 18. In the example represented diagrammatically in FIG. 4, an optical rotary mechanism 90 is provided for this purpose, by means of which the illumination pattern 52 is rotated.

In order to ensure that only s-polarized light is used for generating the illumination pattern and that the best possible modulation contrast is achieved in all directions, a rotary polarizing device 92 is provided upstream of the beam splitter 10 for the purpose of rotating the plane of polarization. Such a rotary polarizing device can be, for example, an electro-optical cell.

An essential feature of the invention is the beam splitter 10 that reflects the excitation light 30 while retaining the polarization state as far as possible.

The angular positions of the rotary mechanism 90 and of the rotary polarizing device 92 are in a fixed relationship, with the result that the polarization of the illumination light is always normal to the diffraction plane. This satisfies the condition demanding the polarization to be oriented in the direction of the lines of the diffraction grating 60.

The second exemplary embodiment of a microscope of the invention shown in FIG. 5 is a variant of the exemplary embodiment shown in FIG. 4. The essential difference is that rather than the illumination light 30 being reflected into the microscope light path, the emission light is reflected out of the microscope light path with the aid of the beam splitter 10 of the invention and transmitted toward a collecting device 42. In the example shown in FIG. 5, illumination light 30 is transmitted through an optical fiber 34 toward the diffraction grating 60 via a lens 65 and a polarizer 54.

FIG. 5 also shows a 45° geometry, that is, the illumination light 30 impinges on the beam splitter 10 at an angle of 45° relative to a surface normal vector of the beam splitter 10. In order to prevent the deleterious effects described above in more detail, more particularly a reduced modulation contrast at certain angular positions of the rotary mechanism and of the rotary polarizing device, the beam splitter 10 of the invention is a dichroic beam splitter, the layer architecture of which is such that, for the purpose of introducing discrete wavelengths, the phase retardations for s-polarization or p-polarization—in this case in transmission—are equal to each other or differ from each other only by an integral multiple of 180°.

The beam splitter 10 that transmits the illumination light 30 while retaining the polarization state as far as possible is also an essential feature of the invention.

Beams of light of different orders of diffraction 61, 62, 63 are again represented diagrammatically in FIG. 5.

A third exemplary embodiment is explained with reference to FIG. 6. Equivalent components are denoted by the same reference numerals as used in FIG. 4. The installation position of a beam splitter 12 for reflecting illumination light 30 into the microscope light path 36 is different in this case with the result that a incident angle of the illumination light 30 relative to a surface normal vector of the beam splitter 12 is less than 45°. This means that an angle 14 formed by the illumination light 30 in relation to the optical axis 38 of the system is less than 90°, unlike the situation shown in FIG. 4. Since the direction of incidence of the illumination light 30 has become approximately equivalent to a normal, i.e. vertical, incidence on the beam splitter, the differences between s-polarization and p-polarization will be smaller. In a case of vertical incidence, which is not feasible in practice, it would not be possible to distinguish between s-polarization and p-polarization. However, setups of the type shown in FIG. 6, in which the installation angle of the beam splitter relative to the optical axis 38 of the system is, for example, less than 20°, may be sufficient for practical applications.

The present invention provides a novel microscope for the structured illumination microscopy, by means of which resolution anisotropies in different directions in space are prevented in a simple manner, and accordingly the advantageous enhancement of resolution in all directions in space is made possible.

1. A microscope
comprising a microscope light path (36) having an optical axis (38) including a beam splitter (10, 12) for coupling illumination light (30) into said microscope light path (36),
including an illumination pattern unit for the purpose of at least one of generating an illuminated pattern (52) on a sample (18) to be examined and generating an illuminated pattern (52) in a sample (18) to be examined,
comprising a rotary device (90) for the purpose of effecting relative rotation about said optical axis (38) between said illumination pattern (52) and said sample (18) to be examined,
wherein
a rotary polarizing device (92) is provided for the purpose of rotating a polarization of said illumination light (30),
the angular positions of said rotary device (90) and of said rotary polarizing device (92) are inflexibly coupled to each other, and
wherein, in order to reduce polarization effects during relative rotation between said illumination pattern (52) and said beam splitter, a beam splitter (10) is used which at least one of reflects and transmits the incident illumination light (30) while substantially maintaining the polarization state.

2. A microscope as defined in claim 1,
wherein the illumination pattern unit is disposed in said microscope light path.

3. The microscope as defined in claim 1
wherein
said beam splitter (12) is installed at an angle relative to said optical axis (38) such that the angle of incidence (14) of said illumination light (30) relative to said optical axis (38) is less than one of: 25 degrees, 20 degrees, 15 degrees and 10 degrees.

4. The microscope as defined in claim 1,
wherein
said beam splitter (10, 12) is a dichroic beam splitter.

5. The microscope as defined in claim 1,
wherein
a layer architecture of said beam splitter (10) is such that, for discrete wavelengths to be reflected or transmitted, the phase retardations for one of s-polarization and p-polarization in at least one of reflection and transmittance are equal to each other or differ from each other only by an integral multiple of 180 degrees.

6. The microscope as defined in claim 1,
wherein
said illumination pattern unit (50) has at least one diffraction device (60) for the purpose of dividing the illumination light (30) into light of different orders of diffraction (61, 62, 63) and optical means for at least one of physically recombining said light of different orders of diffraction on said sample (18) and physically recombining said light of different orders of diffraction in said sample (18).

7. The microscope as defined in claim 6,
wherein
the optical means used is at least one objective lens (20) for at least one of guiding said illumination light (30) onto said sample (18) and guiding said illumination light (30) into said sample (18).

8. The microscope as defined in claim 1,
wherein
said rotary device (90) and said rotary polarizing device (92) are adapted to rotate continuously within at least one angular range.

9. The microscope as defined in claim 6,
wherein
said diffraction device is a diffraction grating (60).

10. The microscope as defined in claim 1,
wherein
said rotary device (90) is one of a mechanical and an optical rotary device.

11. The microscope as defined in claim 1,
wherein
a reflector turret is provided for the accommodation of a plurality of beam splitters.

12. The microscope as defined in claim 6,
wherein
light of the first order of diffraction (61, 62) is used for multibeam interference.

13. The microscope as defined in claim 6,
wherein
light of the first order of diffraction (61, 62) and of the zero order of diffraction (63) is used for multibeam interference.

14. A microscope as defined in claim 1 which is designed as a fluorescence microscope for the structured illumination microscopy.

15. A microscope as defined in claim 1
wherein, in order to reduce polarization effects while effecting relative rotation between said illumination pattern (52) and said beam splitter, said beam splitter (12) is positioned in said optical path (36) such that the angle of incidence (14) of said illumination light (30) relative to a surface normal vector of the beam splitter (12) is less than 45 degrees.

16. A microscope
comprising a microscope light path (36) having an optical axis (38) including a beam splitter (10, 12) for coupling illumination light (30) into said microscope light path (36),
including an illumination pattern unit for the purpose of at least one of generating an illuminated pattern (52) on a sample (18) to be examined and generating an illuminated pattern (52) in a sample (18) to be examined,
comprising a rotary device (90) for the purpose of effecting relative rotation about said optical axis (38) between said illumination pattern (52) and said sample (18) to be examined,
wherein
a rotary polarizing device (92) is provided for the purpose of rotating a polarization of said illumination light (30),
the angular positions of said rotary device (90) and of said rotary polarizing device (92) are inflexibly coupled to each other, and
wherein, in order to reduce polarization effects while effecting relative rotation between said illumination pattern (52) and said beam splitter, said beam splitter (12) is positioned in said optical path (36) such that the angle of incidence (14) of said illumination light (30) relative to a surface normal vector of the beam splitter (12) is less than 45 degrees.

17. A microscope as defined in claim 16,
wherein the illumination pattern unit is disposed in said microscope light path.

18. The microscope as defined in claim 16
wherein
said beam splitter (12) is installed at an angle relative to said optical axis (38) such that the angle of incidence (14) of said illumination light (30) relative to said optical axis (38) is less than one of: 25 degrees, 20 degrees, 15 degrees and 10 degrees.

19. The microscope as defined in claim 16,
wherein
said beam splitter (10, 12) is a dichroic beam splitter.

20. The microscope as defined in claim 16,
wherein
a layer architecture of said beam splitter (10) is such that, for discrete wavelengths to be reflected or transmitted, the phase retardations for one of s-polarization and p-polarization in at least one of reflection and transmittance are equal to each other or differ from each other only by an integral multiple of 180 degrees.

21. The microscope as defined in claim 16,
wherein
said illumination pattern unit (50) has at least one diffraction device (60) for the purpose of dividing the illumination light (30) into light of different orders of diffraction (61, 62, 63) and optical means for at least one of physically recombining said light of different orders of diffraction on said sample (18) and physically recombining said light of different orders of diffraction in said sample (18).

22. The microscope as defined in claim 21,
wherein
the optical means used is at least one objective lens (20) for at least one of guiding said illumination light (30) onto said sample (18) and guiding said illumination light (30) into said sample (18).

23. The microscope as defined in claim 16,
wherein
said rotary device (90) and said rotary polarizing device (92) are adapted to rotate continuously within at least one angular range.

24. The microscope as defined in claim 21,
wherein
said diffraction device is a diffraction grating (60).

25. The microscope as defined in claim 16,
wherein
said rotary device (90) is one of a mechanical and an optical rotary device.

26. The microscope as defined in claim 16,
wherein
a reflector turret is provided for the accommodation of a plurality of beam splitters.

27. The microscope as defined in claim 21,
wherein
light of the first order of diffraction (61, 62) is used for multibeam interference.

28. The microscope as defined in claim 21,
wherein
light of the first order of diffraction (61, 62) and of the zero order of diffraction (63) is used for multibeam interference.

29. A microscope as defined in claim 16 which is designed as a fluorescence microscope for the structured illumination microscopy.

30. A microscope as defined in claim 16,
wherein, in order to reduce polarization effects during relative rotation between said illumination pattern (52) and said beam splitter, a beam splitter (10) is used which at least one of reflects and transmits the incident illumination light (30) while substantially maintaining the polarization state.

31. A dichroic beam splitter,
wherein
said beam splitter (10) is a dichroic beam splitter whose layer architecture is such that, for discrete wavelengths to be reflected or transmitted, the phase retardations for one of s-polarization and p-polarization in at least one of reflection and transmittance are equal to each other or differ from each other only by an integral multiple of 180 degrees.

32. The use of a dichroic beam splitter as defined in claim 31 in a microscope.
